(19) United States
(12) Patent Application Publication
(10) Pub. No.: US 2026/0245126 A1
(43) Pub. Date: Aug. 20, 2026

(54) PURCHASE ASSISTANCE METHOD, STORAGE MEDIUM STORING PURCHASE ASSISTANCE PROGRAM, PURCHASE ASSISTANCE SYSTEM, AND AI-UTILIZING CROSS-BORDER EC SYSTEM

(71) Applicant: SAZO Inc., Nagoya-shi (JP)

(72) Inventors: Maro Gil, Nagoya-shi (JP); Dongyeop KIM, Nagoya-shi (JP)

(21) Appl. No.: 19/641,515

(22) Filed: Apr. 8, 2026

Related U.S. Application Data
(63) Continuation of application No. PCT/JP2025/008924, filed on Mar. 11, 2025.

(30) Foreign Application Priority Data
Mar. 11, 2024 (JP) 2024-037674

(51) Int. Cl. G06Q 30/0601; G06F 40/58

(52) U.S. Cl. CPC G06Q 30/0617; G06F 40/58; G06Q 30/0641

(57) ABSTRACT

A purchase assistance system acquires, via an interface screen displayed on a user terminal, page identification information that identifies a WEB page on which a product that a user desires to purchase is listed. The purchase assistance system automatically extracts, from HTML of the WEB page identified by the page identification information, some necessary information among information on the product listed on the WEB page. The purchase assistance system causes at least a part of the extracted necessary information to be displayed on the interface screen of the user terminal.

### CROSS REFERENCE TO RELATED APPLICATION

This application is a continuation application of International Patent Application No. PCT/JP2025/008924 filed on March 11, 2025, which designated the U.S. and claims the benefit of priority from Japanese Patent Application No. 2024-037674 filed on March 11, 2024. The entire disclosure of all of the above application is incorporated herein by reference.

### TECHNICAL FIELD

The present disclosure relates to a purchase assistance method, a storage medium storing a purchase assistance program, a purchase assistance system, and an AI-utilizing cross-border EC system for assisting a user in purchasing products in foreign countries from the user's country of residence.

### BACKGROUND

As a method by which a user purchases products in foreign countries while being in the user's country of residence, there is a method of using an EC (Electronic Commerce) site that handles overseas products. An EC site is a WEB site that enables buying and selling of products on the Internet. EC sites include mainly a type constructed by a seller to sell the seller's own products (company-operated EC type) and a type in which a plurality of sellers list products (mall type). However, regardless of which type of EC site is used, if the overseas product that the user desires to purchase is not handled on the EC site, the user cannot purchase the desired product.

When an overseas product that the user desires to purchase is not handled on an EC site, the user can also use an import agency service provider. In recent years, services have also been provided in which a request for import of a product can be made to an import agency service provider on a WEB site. However, even when using a WEB site, the user has had to browse an overseas WEB site or the like on which the product is listed, personally ascertain information on the product written in a foreign language, and either input the information into the WEB site of the import agency service provider or write it on paper and send it to the import agency service provider.

In view of the background as described above, technologies intended to support users in purchasing overseas products have also been proposed. For example, according to the technology described in Patent literature 1 (JP2023-100932A), an input field for purchasing a product from overseas is displayed in the web browser of a user terminal together with a product page for a product sold on an EC site. In the input field, the quantity, color, size, and the like of the product are entered.

### SUMMARY

However, even with the technology described in Patent Literature 1, the user ultimately needs to personally ascertain, from among the information described on an overseas WEB site, information for purchasing a product and enter the information into an input field. Accordingly, it is difficult to say that the user can easily purchase an overseas product, and a defect in a sales transaction procedure due to an input error or the like may occur. Further, in conventional services, there have also been cases such as those in which the shipping fee is difficult to understand or those in which the customs duty imposed when importing a product is difficult to understand.

A typical objective of the present disclosure is to provide a purchase assistance method, a purchase assistance program, a purchase assistance system, and an AI-utilizing cross-border EC system that can more appropriately assist a user in purchasing an overseas product from the user's country of residence, by solving at least one of the above-described problems.

A purchase assistance method provided by a typical embodiment of the present disclosure is a purchase assistance method executed in a purchase assistance system that assists a user in purchasing an overseas product from the user's country of residence via an interface screen displayed on a user terminal used by the user, the purchase assistance method comprising: a page identification information acquisition step of acquiring, via the interface screen, page identification information for identifying a WEB page on which a product desired to be purchased by the user is listed; an extraction step of automatically extracting, from HTML of the WEB page identified by the page identification information, some necessary information among information on the product listed on the WEB page; and a necessary information display step of causing at least some of the necessary information extracted in the extraction step to be displayed on the interface screen.

A non-transitory, computer readable, storage medium storing a purchase assistance program provided by a typical embodiment of the present disclosure is a storage medium storing a purchase assistance program executed in a purchase assistance system that assists a user in purchasing an overseas product from the user's country of residence via an interface screen displayed on a user terminal used by the user, wherein, when the purchase assistance program is executed by a control unit of the purchase assistance system, the purchase assistance program causes the purchase assistance system to execute: a page identification information acquisition step of acquiring, via the interface screen, page identification information for identifying a WEB page on which a product desired to be purchased by the user is listed; an extraction step of automatically extracting, from HTML of the WEB page identified by the page identification information, some necessary information among information on the product listed on the WEB page; and a necessary information display step of causing at least some of the necessary information extracted in the extraction step to be displayed on the interface screen.

A purchase assistance system provided by a typical embodiment of the present disclosure is a purchase assistance system that assists a user in purchasing an overseas product from the user's country of residence via an interface screen displayed on a user terminal used by the user, the purchase assistance system executing: a page identification information acquisition step of acquiring, via the interface screen, page identification information for identifying a WEB page on which a product desired to be purchased by the user is listed; an extraction step of automatically extracting, from HTML of the WEB page identified by the page identification information, some necessary information among information on the product listed on the WEB page; and a necessary information display step of causing at least some of the necessary information extracted in the extraction step to be displayed on the interface screen.

An AI-utilizing cross-border EC system provided by a typical embodiment of the present disclosure is an AI-utilizing cross-border EC system that assists a user in purchasing an overseas product from the user's country of residence via an interface screen displayed on a user terminal used by the user, the AI-utilizing cross-border EC system executing: a page identification information acquisition step of acquiring, via the interface screen, page identification information for identifying a WEB page on which a product desired to be purchased by the user is listed; an extraction step of automatically extracting the necessary information by inputting the HTML of the WEB page identified by the page identification information into a mathematical model trained by a machine learning algorithm so as to extract and output the necessary information formed in a WEB page when the HTML of the WEB page is input; and a necessary information display step of causing at least some of the necessary information extracted in the extraction step to be displayed on the interface screen.

According to the purchase assistance method, medium storing the purchase assistance program, purchase assistance system, and AI-utilizing cross-border EC system of the present disclosure, purchase of an overseas product by a user from the user's country of residence is appropriately assisted.

The purchase assistance system exemplified in the present disclosure assists a user in purchasing an overseas product from the user's country of residence via an interface screen displayed on a user terminal used by the user. The purchase assistance method of the present disclosure is executed in the purchase assistance system. The purchase assistance program of the present disclosure is executed by a control unit of the purchase assistance system. The purchase assistance system exemplified in the present disclosure executes a page identification information acquisition step, an extraction step, and a necessary information display step. In the page identification information acquisition step, the purchase assistance system acquires, via an interface screen (user interface screen) displayed on the user terminal, page identification information for identifying a WEB page on which a product desired to be purchased by the user is listed. In the extraction step, the purchase assistance system automatically extracts, from HTML of the WEB page identified by the page identification information, some necessary information from among information on the product listed on the WEB page. In the necessary information display step, the purchase assistance system causes at least some of the necessary information extracted in the extraction step to be displayed on the interface screen of the user terminal.

According to the purchase assistance system exemplified in the present disclosure, when a WEB page (for example, a WEB page of an overseas EC site) is identified by the user, necessary information is automatically extracted from the HTML of the identified WEB page, from among information on the product listed on the WEB page, and is displayed on the interface screen of the user terminal. Accordingly, even without directly browsing the overseas WEB site and personally ascertaining the necessary information, the user can readily and appropriately ascertain the necessary information that has been automatically extracted and displayed, and can perform a procedure for purchasing the product. The possibility that a defect may arise in the purchase and sale procedure is also reduced. Therefore, the procedure for purchasing an overseas product is appropriately assisted.

Note that the method for causing the interface screen to be displayed on the user terminal may be selected as appropriate. For example, the purchase assistance system may cause the interface screen to be displayed on a WEB browser of the user terminal. Further, a dedicated application for implementing the purchase assistance method exemplified in the present disclosure may be installed on the user terminal. In this case, the purchase assistance system may cause the interface screen to be displayed on the user terminal by using the application.

The necessary information to be extracted from the WEB page in the extraction step may be selected as appropriate. For example, at least one of an image (such as a photograph) of the product, the price, a description of the product, and available options (for example, color and size to be selected by the user) may be extracted as the necessary information. In this case, by ascertaining the necessary information displayed on the interface screen, the user can proceed with the purchase procedure more appropriately.

In the extraction step, the purchase assistance system may automatically extract necessary information by analyzing the HTML structure of the WEB page identified by the page identification information (hereinafter referred to as the "specified WEB page"). Hereinafter, processing for analyzing the HTML structure and extracting the necessary information is referred to as "structure analysis processing".

In this case, compared with, for example, a case where a mathematical model trained by a machine learning algorithm is used, the necessary information can be more readily and appropriately extracted in a short time.

In the extraction step, the purchase assistance system may input the HTML of the WEB page identified by the page identification information into a mathematical model, and may extract (acquire) information output by the mathematical model as the necessary information. The mathematical model may be trained by a machine learning algorithm so as to extract and output the necessary information formed in the WEB page when the HTML of the WEB page is input. Hereinafter, processing for extracting the necessary information using a machine learning algorithm is referred to as "AI utilization processing".

When the WEB sites differ, the structures of the HTML of the WEB sites tend to differ greatly. However, by using a mathematical model trained by a machine learning algorithm, the necessary information can be more readily and appropriately extracted from various WEB pages having different HTML structures.

The mathematical model may be trained using a set of input training data and output training data (training dataset). For example, a mathematical model for extracting the necessary information may be trained in accordance with a machine learning algorithm, using a WEB page as input training data and using, as output training data, correct necessary information actually extracted from the WEB page that is the input training data. In this case, the output training data may be, for example, correct necessary information created by an administrator of the purchase assistance system, or may be correct necessary information confirmed or corrected by a user.

In addition, the mathematical model for extracting the necessary information may continue to be trained even after the start of operation of the system, using, as a training dataset, a WEB page identified by the page identification information during use of the system by a user and correct necessary information on the identified WEB page. In this case, the accuracy of extraction of the necessary information by the mathematical model is likely to be further improved.

In the extraction step, the purchase assistance system may execute both the above-described structural analysis processing and AI utilization processing. The purchase assistance system may selectively execute the structural analysis processing and the AI utilization processing according to the WEB page identified by the page identification information.

In the structural analysis processing, the necessary information tends to be appropriately extracted in a short time. On the other hand, since an algorithm for executing the structural analysis processing needs to be constructed according to the type of WEB site (that is, the HTML structure), there may be cases where the structural analysis processing cannot be appropriately executed for a WEB site unsupported by the algorithm for the structural analysis processing. Further, in the AI utilization processing, the necessary information tends to be appropriately extracted from various WEB pages having different HTML structures. On the other hand, the processing time of the AI utilization processing tends to be longer than the processing time of the structural analysis processing. Therefore, by selectively executing the structural analysis processing and the AI utilization processing according to the WEB page, the purchase assistance system can automatically extract the necessary information more appropriately from various WEB pages.

A method for selectively executing the structural analysis processing and the AI utilization processing according to the WEB page may be selected as appropriate. For example, a WEB site on which the structural analysis processing can be executed (that is, a WEB site for which an algorithm for the structural analysis processing has already been constructed) may be stored in advance in a storage device. The purchase assistance system may execute the structural analysis processing if the WEB page identified by the page identification information is on a WEB site on which the structural analysis processing can be executed, and may execute the AI utilization processing if the WEB page is not on a WEB site on which the structural analysis processing can be executed. Further, the purchase assistance system may determine, based on the HTML structure or the like of the WEB page identified by the page identification information, whether or not the WEB page is on a WEB site on which the structural analysis processing can be executed.

When the WEB page identified by the page identification information is displayed in a language of a foreign country different from the language of the user's country of residence, the purchase assistance system may automatically translate at least a part of the necessary information extracted from the HTML (for example, language excluding numerals and symbols, etc.) into the language of the user's country of residence, and may cause the translated information to be displayed on the interface screen of the user terminal. In this case, even if the user is not familiar with the language displayed on the WEB page, the user can easily understand the necessary information displayed on the interface screen in the language of the country of residence. Therefore, the purchase procedure for an overseas product is more appropriately assisted.

In the page identification information acquisition step, the purchase assistance system may acquire, as the page identification information, a URL of a WEB page input by the user on an interface screen displayed on the user terminal. In this case, the user can easily and appropriately grasp the necessary information for purchasing the product merely by inputting, on the interface screen, the URL of the WEB page on which the product desired to be purchased is listed.

It should be noted that a specific method for acquiring the page identification information may be changed. For example, the purchase assistance system may cause one or more product selection sections to be displayed on the interface screen. A URL of a WEB page on which a product is listed may be associated with each product selection section. The purchase assistance system may automatically cause a product selection section for a product recommended to the user to be displayed on the interface screen. Further, the purchase assistance system may search for a product in response to a search instruction from the user, and may cause a product selection section of the searched product to be displayed on the interface screen. When any one of the product selection sections is designated by the user on the interface screen, the purchase assistance system may acquire, as the page identification information, the URL of the WEB page associated with the designated product selection section. In this case, merely by the user designating a product selection section of the product desired to be purchased, the necessary information for purchasing the product is automatically extracted from the HTML of the WEB page and displayed. Accordingly, the purchase procedure for an overseas product is more appropriately assisted.

Further, the user terminal may activate a dedicated application when, in a state where a WEB page on which a product is listed is displayed on an interface screen (for example, a WEB browser or the like), a sharing operation for sharing information of the WEB page with the dedicated application is input. The purchase assistance system may identify the WEB page displayed on the interface screen when the sharing operation is performed on the user terminal, may extract necessary information from the HTML of the identified WEB page, and may cause the necessary information to be displayed in the dedicated application. In this case, the purchase of the product is carried out smoothly by using an information sharing function provided in the user terminal.

The purchase assistance system may further execute a physical information acquisition step, a shipping fee prediction step, and a predicted shipping fee display step. In the physical information acquisition step, the purchase assistance system acquires physical information of the product listed on the WEB site by inputting at least one of the necessary pieces of information extracted in the extraction step into a mathematical model. The mathematical model is trained by a machine learning algorithm so as to output the physical information of the product when the necessary information of the product is input. In the shipping fee prediction step, the purchase assistance system predicts a shipping fee for the product listed on the WEB site on the basis of the physical information acquired in the physical information acquisition step. In the predicted shipping fee display step, the purchase assistance system causes the shipping fee predicted in the shipping fee prediction step to be displayed on the interface screen.

In this case, even when, for example, the physical information of the product is not sufficiently listed on the WEB site, the physical information of the product is appropriately acquired. Based on the acquired physical information of the product, the shipping fee of the product is appropriately predicted and displayed on the interface screen of the user terminal. Accordingly, regardless of the information of the product listed on the WEB site, the shipping fee is predicted with high accuracy and is grasped by the user.

The details of the physical information acquired in the physical information acquisition step can be selected as appropriate. For example, the weight and size of the product listed on the WEB site may be acquired as the physical information. In this case, even when the shipping fee is determined according to both the weight and the size of the product, the shipping fee can be more easily predicted with high accuracy.

The mathematical model for acquiring the physical information of the product may be trained according to a machine learning algorithm using, for example, necessary information of the product as input training data and correct physical information of the product from which the input training data has been extracted as output training data. In this case, the output training data may be, for example, correct physical information input by an administrator of the purchase assistance system or the like.

Further, the mathematical model for acquiring the physical information of the product may be continuously trained even after operation of the system starts, using, as a training data set, the necessary information of the product actually used when the system is used by the user and the correct physical information of the product. In this case, the accuracy of the physical information acquired by the mathematical model is likely to be further improved.

In the physical information acquisition step, the purchase assistance system may acquire the physical information of the product by inputting, into the mathematical model, a plurality of types of necessary information extracted in the extraction step. In this case, compared with a case where one item of necessary information of the product is input into the mathematical model, the accuracy of the acquired physical information is likely to be further improved.

Note that the mathematical model for acquiring the physical information of the product may be trained using a plurality of types of necessary information of the product as input training data. In this case, the accuracy of the physical information of the product output by the mathematical model is likely to be further improved.

A plurality of types of necessary information to be input to the mathematical model may also be selected as appropriate. For example, at least two of the title, category, image, detailed information, and the like of the product may be input to the mathematical model.

In the shipping cost prediction step, the purchase assistance system may apply, to the physical information acquired in the physical information acquisition step, an algorithm (for example, a known 3D packing algorithm or the like) for predicting an appropriate packing box from among a plurality of types of rectangular parallelepiped-shaped packing boxes. The purchase assistance system may predict the shipping cost of the product based on the packing box predicted by the algorithm.

In this case, since the shipping cost is predicted after predicting the packing box actually used when delivering the product, the prediction accuracy of the shipping cost is likely to be further improved.

When the size of the product is acquired as the physical information, the size information may include, for example, information on the maximum value of the width of the product, the maximum value of the depth thereof, and the maximum value of the height thereof. In this case, by applying the algorithm to the maximum value of the width of the product, the maximum value of the depth thereof, and the maximum value of the height thereof, an appropriate packing box is likely to be predicted with high accuracy.

When a plurality of candidate products to be purchased are selected by the user, physical information of each of the selected plurality of products may be acquired. Based on the acquired physical information of each of the plurality of products, the shipping cost for shipping the plurality of products together may be predicted.

In this case, the shipping cost when the user purchases the plurality of products together is appropriately predicted based on the physical information of each of the plurality of products. Note that details of the physical information and a method for constructing a mathematical model for acquiring the physical information are as described above. Further, when the physical information of each product is acquired, as described above, a plurality of types of necessary information regarding each product may be input to the mathematical model.

Note that a method for causing the user to select a plurality of candidate products to be purchased can be appropriately selected. For example, when there are a plurality of products put in a cart by the user, the purchase assistance system may determine the plurality of products put in the cart as candidate products to be purchased by the user. Further, when a plurality of products are further selected by the user from among the plurality of products put in the cart, the purchase assistance system may determine the selected plurality of products as candidate products to be purchased by the user.

In the shipping cost prediction step, the purchase assistance system may apply, to the physical information of each of the plurality of products acquired in the physical information acquisition step, an algorithm for predicting an appropriate packaging box from among a plurality of types of packaging boxes each having a rectangular parallelepiped shape (for example, a known 3D packing algorithm). The purchase assistance system may execute, multiple times while changing the arrangement of the predicted plurality of packaging boxes, a process of predicting an overall packaging box capable of accommodating all of the arranged plurality of packaging boxes (note that a packaging box prediction algorithm such as the above-described 3D packing algorithm may also be used for the process of predicting the overall packaging box). The purchase assistance system may predict, based on an overall packaging box having the smallest volume among the predicted plurality of overall packaging boxes, the shipping cost for shipping the plurality of products together.

In this case, when the plurality of products are collectively accommodated in an overall packaging box and shipped, the overall packaging box having the smallest volume is automatically predicted. Therefore, the shipping cost when the plurality of products are shipped together is predicted more appropriately.

When a plurality of candidate products to be purchased are selected by the user, the purchase assistance system may calculate a difference between a prediction result of the shipping cost when the plurality of products are shipped together and a total price of prediction results of the shipping cost when the plurality of products are shipped separately, and may cause the difference to be displayed on the interface screen. In this case, the user can easily and appropriately grasp an amount of money that can be saved by having the plurality of products shipped together. Accordingly, the user's willingness to purchase the plurality of products is appropriately enhanced.

The purchase assistance system may further execute a customs duty prediction step and a predicted customs duty display step. In the customs duty prediction step, the purchase assistance system predicts, on the basis of information on the product listed on the WEB page identified by the page identification information, a customs duty imposed when the product is imported into the country of residence of the user. In the predicted customs duty display step, the purchase assistance system causes the customs duty predicted in the customs duty prediction step to be displayed on the interface screen.

In this case, the user can determine whether to purchase the product after also taking into consideration a prediction result of the customs duty imposed when importing the product. Accordingly, the purchase procedure for overseas products is more appropriately assisted.

In the customs duty prediction step, the purchase assistance system may acquire a prediction result of the customs duty imposed on the product by inputting information on the product listed on the WEB page identified by the page identification information into a mathematical model. The mathematical model is trained by a machine learning algorithm so as to output a prediction result of the customs duty when information on the product is input. In this case, for various products, the customs duty is likely to be predicted with higher accuracy.

A mathematical model for predicting the customs duty imposed on the product may be trained, for example, according to a machine learning algorithm, with information on the product serving as input training data and correct customs duty imposed on the product serving as output training data. In this case, the output training data may be, for example, correct customs duty or the like input by an administrator or the like of the purchase assistance system.

In the customs duty prediction step, the purchase assistance system may acquire a prediction result of the customs duty imposed on the product by inputting a plurality of pieces of information on the product listed on the WEB page identified by the page identification information into a mathematical model. In this case, compared with a case in which one piece of information on the product is input into the mathematical model, the prediction accuracy of the customs duty prediction result to be acquired is likely to be further improved.

A plurality of types of information to be input into the mathematical model for predicting the customs duty imposed on the product may also be appropriately selected. For example, text information describing the product and an image of the product may be included in the information input into the mathematical model.

In the customs duty prediction step, the purchase assistance system may acquire, using a RAG architecture, text indicating characteristics of the product from a set of texts relating to the product listed on the WEB page identified by the page identification information. The purchase assistance system may acquire a prediction result of the customs duty imposed on the product by inputting the acquired text into the mathematical model.

RAG (Retrieval-Augmented Generation) is a technique that is used in the field of natural language processing and combines an information retrieval system with a generative mathematical model (e.g., a Large Language Model). Specifically, the system first retrieves relevant documents or data fragments related to a specific query (e.g., the latest customs regulations or product categories) from an external database or an internal knowledge base. These retrieved fragments are then provided as additional context to the mathematical model, allowing the model to generate an output based on the most up-to-date or domain-specific information that was not necessarily included in its initial training data. By using a RAG architecture, specific text can be generated based on a large set of texts. Accordingly, it becomes easier to further improve the prediction accuracy of the customs duty to be acquired.

In the customs duty prediction step, the purchase assistance system may acquire a prediction result of the HS code of the product by inputting information on the product listed on the WEB page identified by the page identification information. The mathematical model for HS code prediction is trained by a machine learning algorithm so as to output a prediction result of an HS code in response to information on a product being input. The purchase assistance system may predict the customs duty based on the prediction result of the HS code.

An HS code is a code for classifying goods in international trade. The rate of customs duty is predetermined for each HS code. Accordingly, by predicting the customs duty after predicting the HS code, the prediction accuracy of the customs duty is appropriately improved.

The method for constructing the mathematical model for HS code prediction may be selected as appropriate. For example, the mathematical model may be trained in accordance with a machine learning algorithm, using information on the product as input training data and using, as output training data, a correct HS code manually designated by an operator who has grasped the information on the product. In addition, when a prediction result output by the mathematical model for HS code prediction differs from the correct HS code, the mathematical model may be trained again based on the erroneous prediction result. In this case, the prediction accuracy of the HS code is further improved.

The purchase assistance system may identify, based on the predicted HS code, a rule that may become an issue in customs clearance procedures, and may notify the user of the identified rule. Depending on the classification of the product according to the HS code, rules for limiting export volume, rules for prohibiting export, and the like may be prescribed in customs clearance procedures. Accordingly, by notifying the user of a rule in customs clearance procedures based on the predicted HS code, the user can more appropriately determine whether to purchase the product.

The purchase assistance system may obtain a prediction result of an attribute of the product (for example, at least one attribute among second-hand goods, refrigerated goods, frozen goods, large products, products having a short expiration period, products detained in customs, and the like) by inputting information on the product listed on the WEB page identified by the page identification information into a mathematical model. The mathematical model for product attribute prediction is trained by a machine learning algorithm so as to output a prediction result of an attribute of the product when information on the product is input. The purchase assistance system may notify the user of the obtained information on the attribute of the product. In this case, the user can appropriately determine whether to purchase the product after appropriately understanding the attribute of the product. The mathematical model for product attribute prediction may, for example, be trained according to a machine learning algorithm using information on the product as input training data and using correct attributes personally specified by a worker who has grasped the information on the product as output training data.

The purchase assistance system may calculate, using the shipping fee predicted in the shipping fee prediction step and the customs duty predicted in the customs duty prediction step, a total cost required for the user to purchase the product, and may complete settlement of the total cost for the user in advance before completion of delivery of the product. In this case, since the user can grasp, at an early stage before receiving the product, the total cost required to purchase the product, it becomes easier for the user to make a decision as to whether to purchase the product. The purchase assistance system may, even when the predicted total cost differs from the total cost actually incurred, refrain from billing the user for the difference and refunding the difference to the user. In this case, since the number of times of payment and receipt of money with the user is less likely to increase, the procedure for purchasing the product is simplified.

The purchase assistance system may further execute a link display step of causing a link, which is designated by the user to display the WEB page identified by the page identification information, to be displayed on the interface screen. In this case, by designating the link displayed on the interface screen, the user can easily compare the necessary information displayed on the interface screen with the original WEB page from which the necessary information has been extracted. Therefore, the user can also determine whether to purchase the product after easily confirming the accuracy of the extracted necessary information.

In the necessary information display step, the purchase assistance system may, based on information on an exchange rate between the currency of the user's country of residence and the currency listed on the WEB page, convert the price of the product extracted as the necessary information into the currency of the user's country of residence and display the converted price on the interface screen. In this case, the user can determine whether to purchase the product after grasping the price of the product in the currency of the country of residence.

In the necessary information display step, the purchase assistance system may display the price of the product on the interface screen in both the currency of the user's country of residence and the currency listed on the WEB page. In this case, by grasping the price of the product in both currencies, the user can more easily judge the value of the product more accurately.

The purchase assistance system may further execute a dedicated icon display step of causing, together with a WEB page on which a product desired to be purchased by a user is listed, a dedicated icon operated by the user to instruct display of information on the product to be displayed on the interface screen. When the dedicated icon is operated by the user, the purchase assistance system may identify the WEB page displayed on the interface screen when the dedicated icon was operated. The purchase assistance system may automatically extract necessary information from HTML of the identified WEB page. The purchase assistance system may cause an extended browser to be displayed on the interface screen, and may cause information on the product including the extracted necessary information to be displayed on the displayed extended browser.

In this case, while the WEB page on which the product desired to be purchased is listed is displayed on the interface screen, the user can grasp, on the extended browser, information on the product including the extracted necessary information on the product. Therefore, the user can more appropriately determine whether to purchase the product.

The information on the product to be displayed on the extended browser may be selected as appropriate. For example, the purchase assistance system may cause at least one of the price of the product, an estimated shipping cost, and an estimated customs duty to be displayed on the extended browser. Further, the purchase assistance system may cause at least one of an "Add to Cart" button and a "View on Dedicated Screen" button to be displayed on the extended browser together with the information on the product. When the "Add to Cart" button is operated, the purchase assistance system may add, to a cart, the product for which information is being displayed in the extended browser. Further, when the "View on Dedicated Screen" button is operated, the purchase assistance system may newly display a dedicated interface screen for implementing the purchase assistance method exemplified in the present disclosure. Further, the purchase assistance system may cause price transition information indicating a transition in the price of the product to be displayed on the extended browser.

The purchase assistance system may further execute an auxiliary browser display step of causing, when a WEB page on which a product is listed is displayed on the interface screen, an auxiliary browser that displays information for assisting a user in purchasing the product to be displayed on the interface screen together with the WEB page. When the auxiliary browser is displayed, the purchase assistance system may identify the WEB page that was displayed on the interface screen when the auxiliary browser was displayed. The purchase assistance system may automatically extract necessary information from the HTML of the identified WEB page. The purchase assistance system may cause information on the product including the necessary information to be displayed on the auxiliary browser that has been displayed.

In this case, while the WEB page on which the product is listed is displayed on the interface screen, the user can grasp, on the auxiliary browser that is automatically displayed, information on the product including the extracted necessary information on the product. Therefore, the user can more appropriately determine whether to purchase the product.

A specific method for detecting that a WEB page on which a product is listed (hereinafter referred to as a "product listing page") has been displayed on the interface screen may be selected as appropriate. For example, a mathematical model that outputs a probability that the WEB page displayed on the interface screen is a product listing page may be constructed in advance in accordance with a machine learning algorithm. The purchase assistance system may acquire the probability that the displayed WEB page is a product listing page by inputting information on the displayed WEB page (for example, HTML or the like) into the mathematical model. The purchase assistance system may detect, on the basis of the acquired probability, that the displayed WEB page is a product listing page.

The information on the product to be displayed on the auxiliary browser may be selected as appropriate. For example, the purchase assistance system may cause at least one of the price of the product, predicted shipping charges, predicted customs duties, and the like to be displayed on the auxiliary browser. Further, as described above, the purchase assistance system may cause at least one of an "Add to Cart" button and a "View on Dedicated Screen" button to be displayed on the auxiliary browser together with the information on the product. Further, the purchase assistance system may cause price transition information indicating a transition in the price of the product to be displayed on the auxiliary browser.

### BRIEF DESCRIPTION OF THE DRAWINGS

FIG. 1 is a block diagram showing a schematic configuration of a purchase assistance system 1 and a user terminal 20.

FIG. 2 is a flowchart of purchase assistance processing executed by the purchase assistance system 1 according to the present embodiment.

FIG. 3 is a diagram showing an example of an interface screen (a home screen 40) displayed on a display unit 26 of the user terminal 20.

FIG. 4 is a flowchart of product-specific information display processing executed during the purchase assistance processing.

FIG. 5 is a diagram showing an example of an interface screen (a product-specific screen 50) displayed on the display unit 26 of the user terminal 20.

FIG. 6 is a flowchart of combined-delivery shipping fee prediction processing executed by a purchase assistance system 1 according to a first modified example.

FIG. 7 is a diagram showing an example of a state in which a dedicated icon 70 and an extended browser 71 are displayed on a general-purpose interface screen displayed on a display unit 26 of a user terminal 20.

FIG. 8 is a diagram showing an example of a state in which an auxiliary browser 73 is displayed on a general-purpose interface screen displayed on the display unit 26 of the user terminal 20.

FIG. 9 is a diagram showing a state in which an information sharing instruction button 74 and an information sharing icon field 75 are displayed on a general-purpose interface screen displayed on the display unit 26 of the user terminal 20.

### DETAILED DESCRIPTION

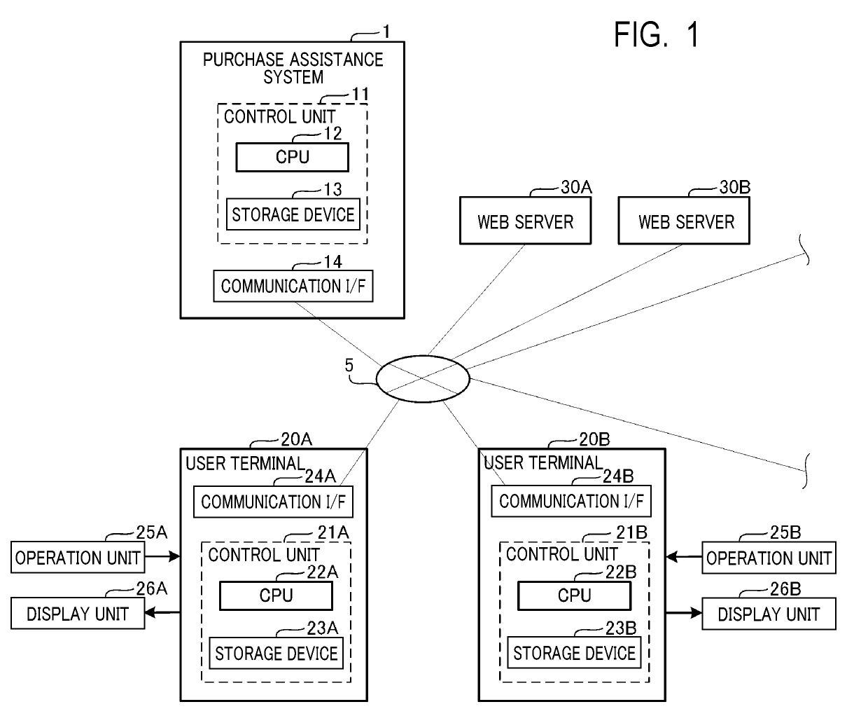

Hereinafter, one typical embodiment in the present disclosure will be described with reference to the drawings. First, with reference to FIG. 1, an example of the configurations of purchase assistance system (AI-based cross-border EC system) 1 and user terminal 20 in the present embodiment will be schematically described.

The purchase assistance system 1 implements a service for assisting a user in purchasing overseas products. As one example, a server, which is a type of information processing apparatus, is used as the purchase assistance system 1 in the present embodiment. Specifically, in the present embodiment, a server of a manufacturer providing cloud services (a so-called cloud server) is used as the purchase assistance system 1. However, a server other than a cloud server may be used as the purchase assistance system 1. As the purchase assistance system 1, an information processing apparatus other than a server (for example, a personal computer (hereinafter, referred to as a "PC"), etc.) may be used. The number of devices constituting the purchase assistance system 1 may be one, or may be a plurality. For example, an information processing apparatus and a database may cooperate to function as the purchase assistance system 1, or a plurality of information processing apparatuses may cooperate to function as the purchase assistance system 1.

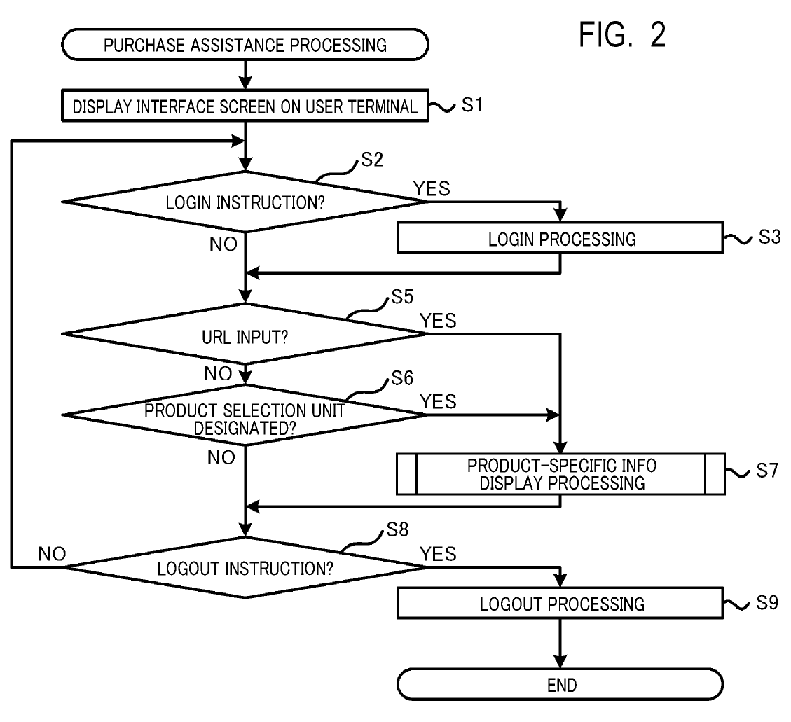

The purchase assistance system 1 includes a control unit 11 that performs various processing controls, and a communication I/F 14. The control unit 11 includes a CPU 12, which is a controller that governs control, and a storage device 13 capable of storing programs, data, and the like. The storage device 13 stores a purchase assistance program for executing purchase assistance processing (see FIG. 2), which will be described later. Further, the storage device in the present embodiment stores data necessary for causing the user terminal 20 to display a dedicated interface screen (details of which will be described later). The communication I/F 14 connects the purchase assistance system 1 to external devices (for example, a plurality of user terminals 20 and a plurality of WEB servers 30) via a network 5 (for example, the Internet or the like).

The user terminal 20 (20A, 20B) is used by a user who utilizes a service provided by the purchase assistance system 1. The user terminal 20 exemplified in the present embodiment is a personal computer. However, a portable terminal such as a smartphone or a tablet terminal may be used as the user terminal 20. The user terminal 20 includes a control unit 21 (21A, 21B) that performs various control processes, and a communication I/F 24 (24A, 24B). The control unit 21 includes a CPU 22 (22A, 22B), which is a controller that governs control, and a storage device 23 (23A, 23B) capable of storing programs, data, and the like. Further, the communication I/F 24 connects the user terminal 20 to external devices (for example, the purchase assistance system 1 and a plurality of WEB servers 30) via the network 5.

The user terminal 20 is connected to an operation unit 25 and a display unit 26. The operation unit 25 is operated by the user to input various instructions to the user terminal 20. As the operation unit 25, for example, at least one of a keyboard, a mouse, and a touch panel can be used. It should be noted that, together with the operation unit 25 or instead of the operation unit 25, a microphone or the like for inputting various instructions may be used. The display unit 26 displays various images. As the display unit 26, various devices for displaying images (for example, at least one of a monitor, a projector, and a head-mounted display) can be employed. Needless to say, instead of the operation unit 25 and the display unit 26 externally connected to the user terminal 20, an operation unit and a display unit included in the user terminal 20 may be used.

The WEB server 30 (30A, 30B) stores data necessary for causing an information processing apparatus to display a WEB page, such as HTML and image data constituting the WEB page. When there is access to a WEB page, the WEB server 30 provides the information processing apparatus with data for constituting the accessed WEB page. As a result, the information processing apparatus (for example, the user terminal 20 or the like) can cause the display unit (for example, the display unit 26 or the like) to display the accessed WEB site.

An example of purchase assistance processing executed by the purchase assistance system 1 of the present embodiment will be described with reference to FIGS. 2 to 5. In the purchase assistance processing, necessary information is automatically extracted from a WEB page on which a product is listed (for example, a WEB page in which a language different from the language of the user's country of residence is used), and is displayed on an interface screen on the display unit 26 of the user terminal 20. The interface screen of the present embodiment is configured in accordance with a predetermined format. Accordingly, the user can perform a procedure for purchasing the product after easily and appropriately grasping the necessary information that has been automatically extracted and displayed on the interface screen, without directly browsing an overseas WEB site and independently grasping the necessary information. The possibility of a defect occurring in the sales and purchase procedure is also reduced.

The purchase assistance processing of the present embodiment is executed by the CPU 12 of the purchase assistance system 1. When the user operates the operation unit 25 of the user terminal 20 and inputs to the user terminal 20 an instruction to display a dedicated interface screen exemplified in the present embodiment, the CPU 12 executes the purchase assistance processing shown in FIG. 2 in accordance with the purchase assistance program stored in the storage device 13.

First, the CPU 12 causes the user terminal 20 (in the present embodiment, the display unit 26 whose display is controlled by the user terminal 20) to display a dedicated interface screen (the home screen 40 in S1) for providing a purchase assistance service to the user (S1). In the present embodiment, a case in which the purchase assistance system 1 causes a dedicated interface screen to be displayed on the WEB browser of the user terminal 20 is exemplified. However, the method of causing the interface screen to be displayed on the user terminal 20 may be changed. For example, a dedicated application for providing the purchase assistance service to the user may be installed on the user terminal 20. In this case, the purchase assistance system 1 may cause the interface screen to be displayed on the user terminal 20 by using the application.

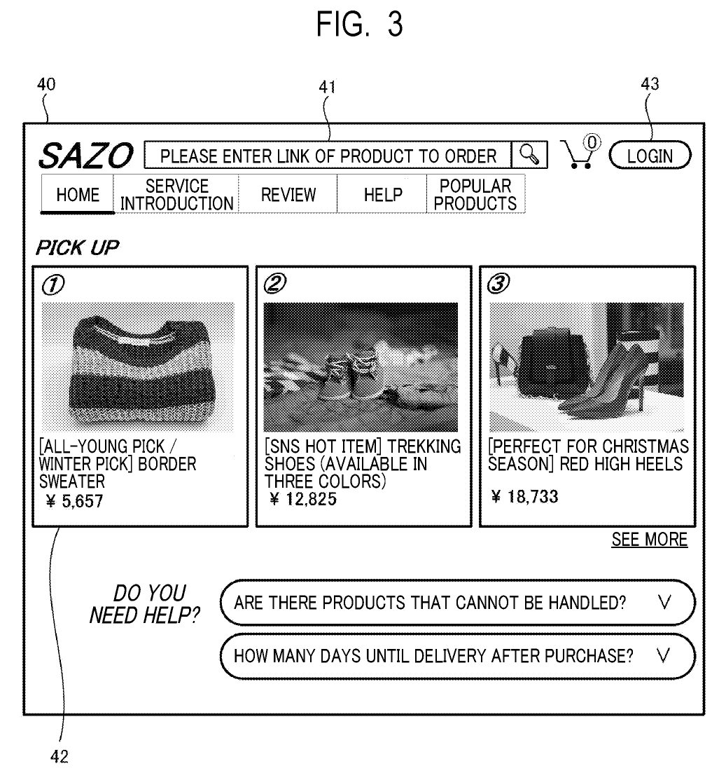

With reference to FIG. 3, an example of a display aspect of the home screen 40, which is one of the interface screens, will be described. The home screen 40 illustrated in FIG. 3 is provided with a URL input unit 41, a product selection unit 42, and a login button 43. The login button 43 is operated when the user logs in to the purchase assistance service.

A URL of a WEB page on which a product that the user wishes to purchase is listed is input into the URL input unit 41. When a URL is input into the URL input unit 41, the CPU 12 automatically extracts necessary information to be presented to the user from the WEB page identified by the input URL, and causes the necessary information to be displayed on an interface screen (in the present embodiment, a product-specific screen 50 described later).

The product selection unit 42 is displayed in order to present information on a product to the user as a purchase candidate. Each product selection unit 42 includes information on an outline of the product (for example, an image of the product, a brief description, and a price). In the example shown in FIG. 3, the purchase assistance system 1 automatically causes the interface screen 40 to display, as "PICK UP," the product selection units 42 for each of a plurality of products recommended to the user. However, it is also possible to change the display method of the product selection units 42. For example, when a search instruction by the user is input via the user terminal 20, the purchase assistance system 1 may also search for a product according to the input search instruction and cause the interface screen to display the product selection unit 42 of the searched product. Each product selection unit 42 is associated with a URL of a WEB page on which the product is listed. When any one of the product selection units 42 is designated by the user on the interface screen, the purchase assistance system 1 acquires the URL of the WEB page associated with the designated product selection unit 42. The purchase assistance system 1 automatically extracts necessary information to be presented to the user from the WEB page identified by the acquired URL, and causes the necessary information to be displayed on an interface screen (in the present embodiment, a product-specific screen 50 described later).

Returning to the description of FIG. 2. The CPU 12 determines whether or not a login instruction has been input by the user (S2). When the login instruction has been input (S2: YES), the CPU 12 executes login processing in accordance with the input instruction (S3). If no login instruction has been input (S2: NO), the CPU 12 determines whether or not a URL has been input into the URL input unit 41 (S5). If no URL has been input (S5: NO), the CPU 12 determines whether or not any one of the product selection units 42 has been designated by the user (S6). If no product selection unit 42 has been designated (S6: NO), the CPU 12 determines whether or not a logout instruction has been input by the user (S8). If no logout instruction has been input (S8: NO), the process returns to S2, and the processing of S2 to S8 is repeated. It should be noted that, when a logout instruction is input by the user (S8: YES), the CPU 12 performs logout processing (S9) and ends the purchase assistance processing.

When a URL is input into the URL input unit 41 (S5: YES), the CPU 12 executes product-specific information display processing (S7), with the input URL serving as page identification information for identifying a WEB page on which a product that the user wishes to purchase is listed. Further, when any one of the product selection units 42 is designated (S6: YES), the CPU 12 executes product-specific information display processing (S7), with the URL of the WEB page associated with the designated product selection unit 42 serving as page identification information. That is, the processing of S5 and S6 may also be expressed as processing for acquiring page identification information.

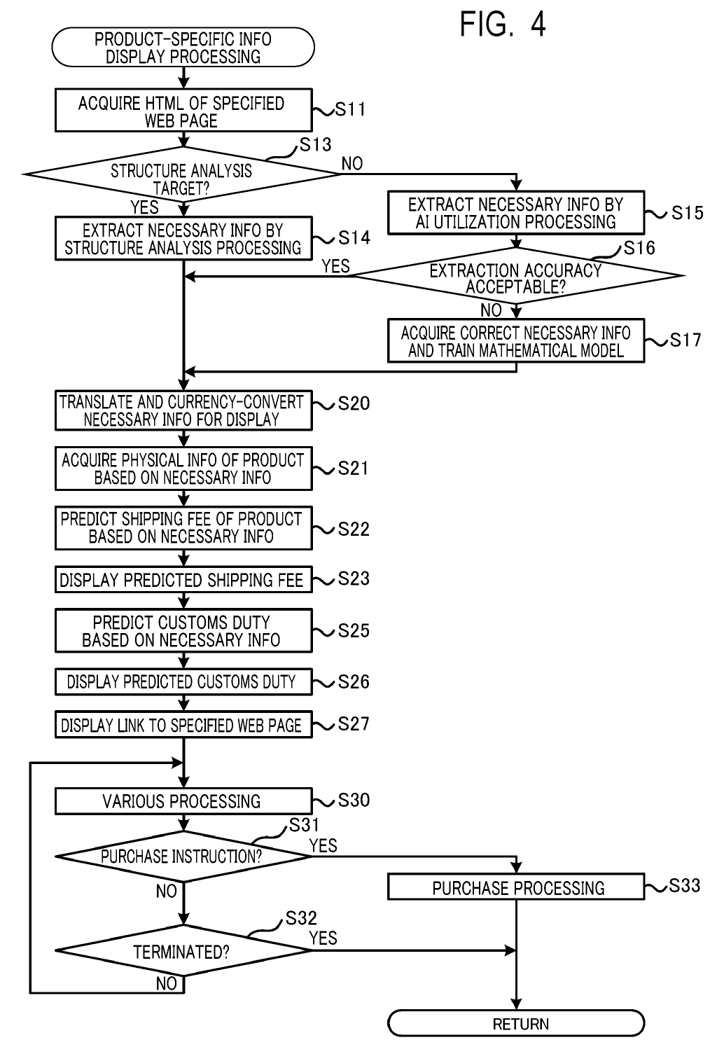

With reference to FIG. 4, the product-specific information display processing will be described. First, the CPU 12 acquires the HTML of the WEB page identified by the page identification information (URL in the present embodiment) (S11). The CPU 12 automatically extracts, from the HTML acquired in S11, some necessary information from among information on the product listed on the WEB page (S13 to S15). The type of necessary information to be automatically extracted can be selected as appropriate. As one example, in the present embodiment, at least one of an image of the product (a photograph or the like), a price, a description of the product, and available options (for example, color and size to be selected by the user) is extracted as the necessary information. Accordingly, by grasping the automatically extracted necessary information, the user can proceed with the purchase procedure more appropriately.

The purchase assistance system 1 according to the present embodiment can execute structural analysis processing (S14) and AI utilization processing (S15) as processing for automatically extracting necessary information from a WEB site.

In the structural analysis processing (S14), the CPU 12 automatically extracts the necessary information by analyzing the HTML structure of the WEB page identified by the page identification information (URL in the present embodiment) (hereinafter, also referred to as a "specific WEB page").

According to the structural analysis processing (S14), the necessary information can be automatically extracted with higher accuracy while reducing the processing load.

In the AI utilization processing (S15), the CPU 12 inputs the HTML of the WEB page identified by the page identification information (URL in the present embodiment) into a mathematical model for extracting necessary information, thereby extracting (acquiring), as the necessary information, information output by the mathematical model. The mathematical model for extracting necessary information is trained by a machine learning algorithm so that, when the HTML of a WEB page is input, the necessary information formed in the WEB page is extracted and output. As one example, in the present embodiment, the mathematical model for extracting necessary information is trained using a set of input training data and output training data (training data set). Specifically, the mathematical model for extracting necessary information is trained according to a machine learning algorithm, with a WEB page as the input training data and correct necessary information actually extracted from the WEB page serving as the input training data as the output training data. The output training data may be, for example, correct necessary information constructed by the administrator of the purchase support system 1, or may be correct necessary information confirmed or corrected by the user.

As described above, when WEB sites differ, the structures of the HTML of the WEB sites tend to differ greatly. However, by using the mathematical model for extracting necessary information trained by the machine learning algorithm, it becomes easier to appropriately extract the necessary information from various WEB pages having different HTML structures.

The purchase assistance system 1 according to the present embodiment selectively executes a structural analysis process (S14) and an AI utilization process (S15) in accordance with the WEB page specified by the page identification information. As described above, in the structural analysis process (S14), it becomes easier to appropriately extract the necessary information in a short time. On the other hand, since an algorithm for executing the structural analysis process needs to be constructed in accordance with the type of WEB site (that is, the HTML structure), there may be cases where the structural analysis process cannot be appropriately executed for a WEB site not supported by the algorithm of the structural analysis process. On the other hand, in the AI utilization process (S15), it becomes easier to appropriately extract the necessary information from various WEB pages having different HTML structures. On the other hand, the processing time of the AI utilization process tends to be longer than the processing time of the structural analysis process. Therefore, by selectively executing the structural analysis process and the AI utilization process in accordance with the WEB page, the purchase assistance system 1 can automatically extract the necessary information more appropriately from various WEB pages.

As an example, in the purchase assistance system 1 according to the present embodiment, WEB sites on which the structural analysis process (S14) can be executed (that is, WEB sites for which the algorithm of the structural analysis process has already been constructed) are stored in advance in the storage device 13. If the WEB page specified by the page identification information is from a WEB site on which the structural analysis process can be executed (S13: YES), the CPU 12 executes the structural analysis process. On the other hand, if the WEB page specified by the page identification information is not from a WEB site on which the structural analysis process can be executed (S13: NO), the CPU 12 executes the AI utilization process (S15).

When the AI utilization process (S15) has been executed, the CPU 12 determines whether or not the extraction accuracy of the necessary information extraction performed by the AI utilization process satisfies a criterion (whether or not the extraction accuracy is acceptable) (S16). The determination in S16 may be made, for example, based on a determination result by an administrator of the purchase assistance system 1, or may be made based on a determination result by a user. If the extraction accuracy satisfies the criterion (S16: YES), the CPU 12 adopts the information automatically extracted in S15 as it is as the necessary information, and the process proceeds to S20. On the other hand, if the extraction accuracy does not satisfy the criterion (S16: NO), the CPU 12 acquires correct necessary information to be extracted from the specified WEB page. The CPU 12 trains the mathematical model for extracting necessary information by using, as a training data set, the specified WEB page specified by the page identification information and the correct necessary information in the specified WEB page (S17). Therefore, the accuracy of the output by the mathematical model for extracting necessary information is likely to be further improved. The correct necessary information acquired in S17 may be input, for example, by an administrator of the purchase assistance system 1, or may be input by a user. Further, if the extraction accuracy does not satisfy the criterion (S16: NO), instead of the information automatically extracted in S15, the correct information acquired in S17 is taken as the necessary information, and the process proceeds to S20.

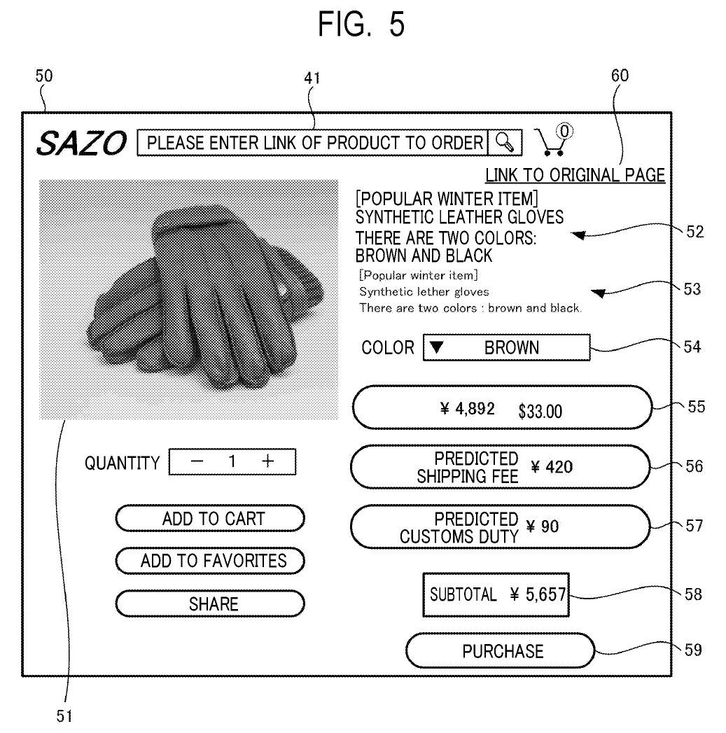

When the necessary information has been extracted (acquired), the CPU 12 causes at least a part of the extracted necessary information to be displayed on an interface screen (in the present embodiment, the product-specific screen 50 illustrated in FIG. 5) (S20).

The product-specific screen 50 illustrated in FIG. 5 is provided with, in addition to the above-described URL input section 41, an image display section 51, a country-of-residence-language description display section 52, a local-language description display section 53, an option selection section 54, a product price display section 55, a predicted shipping fee display section 56, a predicted customs duty display section 57, a subtotal display section 58, a purchase button 59, and a link 60 for displaying the original page.

In the image display section 51, an image of the product extracted from the WEB page as necessary information is displayed.

In the country-of-residence-language description display section 52, the product description extracted from the WEB page as necessary information is displayed in the language of the country of residence of the user of the user terminal 20. That is, in the processing of S20 (see FIG. 4), when the WEB page specified by the user is expressed in a language of a foreign country different from the language of the country of residence of the user, the purchasing assistance system 1 automatically translates at least a part of the necessary information extracted from the specified WEB page (in the example shown in FIG. 5, the product description and product options described later) into the language of the country of residence of the user, and causes the same to be displayed on the interface screen (the product-specific screen 50). Accordingly, even if the user is not familiar with the language displayed on the WEB page, the user can easily grasp the necessary information displayed on the interface screen in the language of the country of residence.

In the local-language description display section 53, the product description extracted from the WEB page as necessary information is displayed in the language used in the WEB page (that is, the local language). Accordingly, the user can more accurately grasp the content of the product by comparing the product description in the language of the country of residence with the product description in the local language.

In the option selection section 54, information on options of the product extracted from the WEB page as necessary information is displayed. In the processing of S20 (see FIG. 4), the purchasing assistance system 1 causes information on a plurality of options of the product to be displayed in the option selection section 54 in a state selectable by the user. When any one of the plurality of options is selected by the user, the purchasing assistance system 1 executes other processing (for example, purchase processing (S33) described later) with the product of the selected option being treated as the product that the user wishes to purchase. As one example, the option selection section 54 of the present embodiment causes the user to select an option by displaying a plurality of options in a pull-down format. However, it goes without saying that the display method for the options by the option selection section 54 can be changed.

In the product price display section 55, information on the price of the product extracted from the WEB page as necessary information is displayed. In the processing of S20, the purchasing assistance system 1 converts the price of the product extracted as necessary information into the currency of the country of residence of the user, based on information on the exchange rate between the currency of the country of residence of the user using the user terminal 20 and the currency shown on the WEB page, and causes the converted price to be displayed in the product price display section 55. Accordingly, the user can determine whether or not to purchase the product after grasping the price of the product in the currency of the country of residence. Note that the purchasing assistance system 1 may cause the exchange rate to be displayed together with the price of the product. Further, the purchasing assistance system 1 of the present embodiment causes the price of the product to be displayed in the product price display section 55 in both the currency of the country of residence of the user and the currency shown on the WEB page. Accordingly, the user can more easily determine the value of the product more accurately by grasping the price of the product in both currencies.

In the predicted shipping charge display section 56, a prediction result of the shipping charge for delivering the product listed on the WEB page to the user (predicted shipping charge) is displayed. Although details will be described later, the purchasing assistance system 1 can predict the shipping charge based on necessary information extracted from the WEB page.

In the predicted customs duty display section 57, a prediction result of the customs duty imposed when importing the product listed on the WEB page into the country of residence of the user (predicted customs duty) is displayed. Although details will be described later, the purchasing assistance system 1 can predict the customs duty based on information on the product listed on the WEB page.

In the subtotal display section 58, the total price of the price of the product, the predicted shipping charge, and the predicted customs duty is displayed. The purchase button 59 is operated by the user when carrying out a purchase procedure for the product displayed on the product-specific screen 50. The original page display link 60 is a link operated by the user to cause a WEB page (original page) on which the product is listed to be displayed.

The description now returns to FIG. 4. The CPU 12 executes processing for predicting and displaying a shipping charge for delivering the product listed on the WEB page to the user (S21 to S23). First, by inputting the necessary information of the product acquired in S11 to S17 into the mathematical model for acquiring physical information of the product, the CPU 12 acquires information output by the mathematical model as physical information of the product (S21). The mathematical model for acquiring physical information is trained by a machine learning algorithm so as to output physical information of the product when the necessary information of the product is input. As one example, in the present embodiment, the mathematical model for acquiring physical information is trained according to a machine learning algorithm using the necessary information of the product as input training data and correct physical information of the product from which the input training data has been extracted as output training data. The output training data may be, for example, correct physical information input by an administrator of the purchasing assistance system or the like. Further, the mathematical model for acquiring physical information is continuously trained even after operation of the service has started, using, as a training data set, the necessary information of the product actually used when the user uses the purchasing assistance service and the correct physical information of the product. Accordingly, it becomes easier to further improve the accuracy of the physical information acquired by the mathematical model.

Specifically, in the processing of S21, the CPU 12 acquires physical information of the product listed on the WEB site by inputting a plurality of types of necessary information acquired in S11 to S17 into the mathematical model for acquiring physical information of the product. Accordingly, compared with a case where one piece of necessary information of the product is input into the mathematical model, it becomes easier to further improve the accuracy of the acquired physical information. It should be noted that the mathematical model for acquiring physical information is trained using a plurality of types of necessary information of the product as input training data. As one example, in the present embodiment, physical information of the product is acquired with high accuracy by inputting the title, category, image, and detailed information of the product into the mathematical model for acquiring physical information.

In the present embodiment, at least the weight and size of the product are acquired as physical information. Accordingly, even when the shipping cost is determined according to both the weight and the size of the product, the shipping cost becomes easier to predict with high accuracy.

Next, the CPU 12, based on the physical information of the product acquired in the processing of S21, predicts the shipping cost of the product (S22). The CPU 12 causes the shipping cost predicted in S22 to be displayed on the interface screen (in the present embodiment, the predicted shipping cost display section 56 of the product-specific screen 50) (S23). Accordingly, even when the physical information of the product is not sufficiently listed on the WEB site, for example, the shipping cost is predicted with high accuracy and presented to the user.

Specifically, in the processing of S22, the CPU 12 applies, to the physical information of the product acquired in S21, an algorithm for predicting an appropriate packing box from among a plurality of types of packing boxes each having a rectangular parallelepiped shape (in the present embodiment, a known 3D packing algorithm). The CPU 12 predicts the shipping cost of the product based on the packing box predicted by the algorithm. Accordingly, since the shipping cost is predicted after the packing box actually used for delivery of the product has been predicted, the prediction accuracy of the shipping cost becomes easier to further improve. It should be noted that the information on the size of the product acquired as necessary information in S11 to S17 includes information on the maximum width, the maximum depth, and the maximum height of the product. Accordingly, by applying the algorithm to the maximum width, the maximum depth, and the maximum height of the product, it becomes easier to predict an appropriate packing box with high accuracy.

The CPU 12 predicts a tariff based on information on the product listed on the WEB page (S25). The CPU 12 causes the tariff predicted in S25 to be displayed on the interface screen (in the present embodiment, the predicted tariff display section 57 of the product-specific screen 50) (S26). Accordingly, the user can determine whether to purchase the product after also taking into consideration the prediction result of the tariff imposed when importing the product.

In the processing of S25, the CPU 12 inputs information on the product listed on the WEB page into a mathematical model for tariff prediction, thereby acquiring, as a prediction result of the tariff, a price output by the mathematical model. The mathematical model for tariff prediction is trained by a machine learning algorithm so as to output a prediction result of the tariff when information on a product is input. Accordingly, for various products, prediction can be made with higher accuracy. As an example, the mathematical model for tariff prediction of the present embodiment is trained in accordance with a machine learning algorithm, with information on products as input training data and correct tariffs imposed on the products as output training data. The output training data may be, for example, correct tariffs input by an administrator of the purchase assistance system 1 or the like.

Specifically, in the processing of S25, the CPU 12 obtains a prediction result of a tariff imposed on a product by inputting a plurality of pieces of information on the product listed on the WEB page into a mathematical model for tariff prediction. Accordingly, compared with a case where one piece of information on the product is input into the mathematical model, the prediction accuracy of the tariff to be obtained is likely to be further improved. As an example, in the present embodiment, text information describing the product and an image of the product are included in the information input into the mathematical model for tariff prediction.

Further, in the processing of S25, the CPU 12 acquires, using RAG, text indicating characteristics of the product from a set of texts relating to the product listed on the WEB page. RAG (Retrieval-Augmented Generation) is a technique used in the field of natural language processing. By using RAG, specific text can be generated on the basis of a set of a large amount of text. The CPU 12 obtains a prediction result of a tariff imposed on the product by inputting the acquired text into the mathematical model for tariff prediction. As a result, the tariff is likely to be predicted with high accuracy on the basis of the characteristics of the product.

The CPU 12 causes an original-page display link 60, which is designated by a user in order to display a WEB page specified by page identification information (a URL in the present embodiment), to be displayed on an interface screen (a product-specific screen 50 in the present embodiment). Accordingly, by designating the link displayed on the product-specific screen 50, the user can easily compare the necessary information displayed on the product-specific screen 50 with the original WEB page from which the necessary information has been extracted. Therefore, the user can also determine whether to purchase the product after easily confirming the accuracy of the extracted necessary information.

The CPU 12 executes various types of processing (S30) while causing the interface screen (the product-specific screen 50) illustrated in FIG. 5 to be displayed on the display unit 26 of the user terminal 20. For example, when a quantity changing section in the product-specific screen 50 is operated by the user, the CPU 12 changes the quantity of the product in accordance with an operation instruction. The CPU 12 recalculates, in accordance with the changed quantity, the prices to be displayed in the product price display section 55, the predicted shipping cost display section 56, the predicted tariff display section 57, and the subtotal display section 58, and causes the recalculated prices to be displayed. Further, when an “Add to Cart” button in the product-specific screen 50 is operated by the user, the CPU 12 adds information on the product displayed on the product-specific screen 50 to the user's cart. When a “Favorite” button in the product-specific screen 50 is operated by the user, the CPU 12 adds information on the product displayed on the product-specific screen 50 to the user's favorites. When a “Share” button in the product-specific screen 50 is operated by the user, the CPU 12 executes processing for sharing information on the product displayed on the product-specific screen 50 with another user designated by the user.

The CPU 12 determines whether or not the purchase button 59 in the product-specific screen 50 has been operated by the user (S31). If the purchase button 59 has not been operated (S31: NO), the CPU 12 determines whether or not an instruction to terminate display of the product-specific screen 50 has been input by the user (S32). If the termination instruction has not been input (S32: NO), the processing of S30 to S32 is repeated, and a standby state is entered. When the purchase button 59 is operated (S31: YES), the CPU 12 executes purchase processing of the product in accordance with an instruction input by the user (S33), and the processing returns to the purchase assistance processing (see FIG. 2). When the termination instruction is input, the processing directly returns to the purchase assistance processing (see FIG. 2).

### First Modification

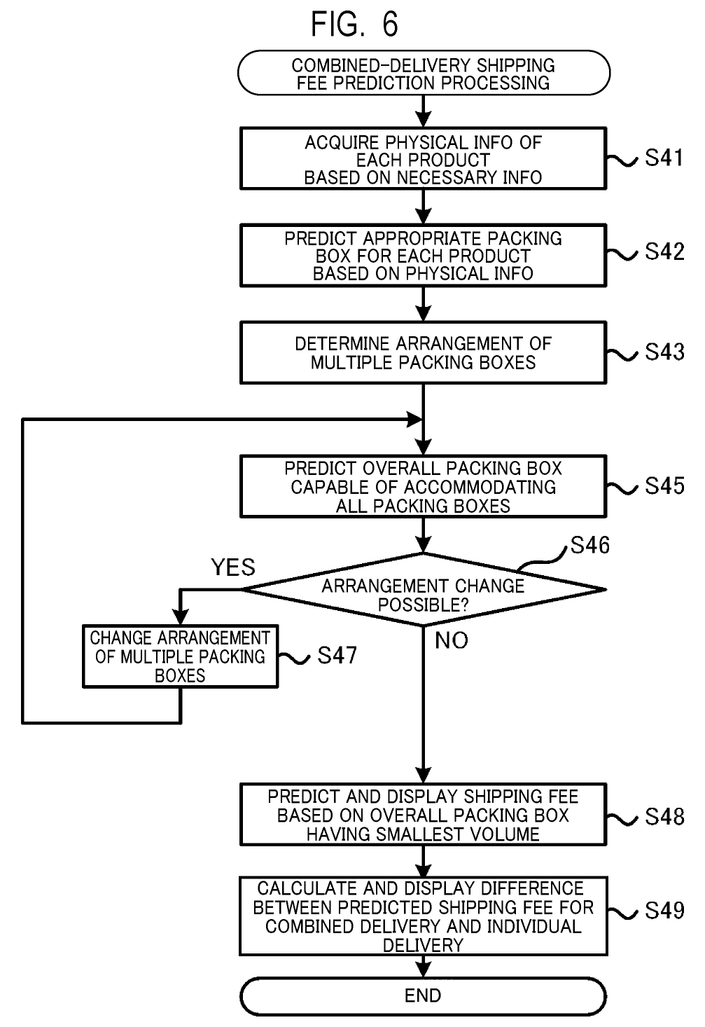

A first modification of the above embodiment will be described with reference to FIG. 6. The purchase assistance system 1 according to the first modification can predict a shipping fee for a case in which a plurality of products are collectively delivered by executing the collective-delivery shipping-fee prediction processing shown in FIG. 6. For example, when a plurality of products placed in a cart by the user are present, the purchase assistance system 1 may start the collective-delivery shipping-fee prediction processing with the plurality of products placed in the cart as candidate products to be purchased by the user. Further, when a plurality of products are further selected by the user from among the plurality of products placed in the cart, the purchase assistance system 1 may start the collective-delivery shipping-fee prediction processing with the selected plurality of products as candidate products to be purchased by the user.

As shown in FIG. 6, the CPU 12 of the purchase assistance system 1 acquires physical information of each of the plurality of products on the basis of necessary information of each of the plurality of products set as candidate products to be purchased by the user (S41). As the processing for acquiring the necessary information of each product, processing similar to S11 to S17 of the above embodiment (see FIG. 4) can be employed. Further, as the processing for acquiring the physical information of each product, processing similar to S21 of the above embodiment (see FIG. 4) can be employed. Next, the CPU 12 applies, to the physical information of each of the plurality of products acquired in S41, an algorithm for predicting an appropriate packing box from among a plurality of types of packing boxes each having a rectangular parallelepiped shape (in the present embodiment, a known 3D packing algorithm). As a result, a packing box suitable for packing (accommodating) each of the plurality of products is predicted (S42). As the processing for predicting a packing box suitable for packing a product, processing similar to S22 of the above embodiment (see FIG. 4) can be employed.

Next, the CPU 12 determines an initial arrangement for collectively delivering the plurality of packing boxes predicted in S42 (S43). The CPU 12 predicts an overall packing box capable of packing (accommodating) all of the plurality of packing boxes arranged in accordance with the determination in S43 (S45). In S45 of the first modified example, the CPU 12 applies an algorithm for predicting, from among a plurality of types of overall packing boxes each having a rectangular parallelepiped shape, an overall packing box suitable for accommodating all of the plurality of packing boxes (in the first modified example, a known 3D packing algorithm). As a result, an appropriate overall packing box is predicted. The predicted overall packing box is stored in the storage device 13. Note that, if no appropriate overall packing box is predicted in S45, the processing proceeds directly to S46.

Next, the CPU 12 determines whether the arrangement of the plurality of packing boxes predicted in S42 can be changed (S46). When the arrangement of the plurality of packing boxes is changed, the orientation (angle) of at least one of the packing boxes is also changed. If the arrangement can be changed (S46: YES), the CPU 12 changes the arrangement of the plurality of packing boxes to a new arrangement (S47), and predicts an overall packing box capable of packing (accommodating) all of the plurality of packing boxes arranged in accordance with the determination in S47 (S45). That is, while changing the arrangement of the plurality of packing boxes, the CPU 12 executes multiple times processing for predicting an overall packing box capable of accommodating all of the plurality of arranged packing boxes (S43 to S47).

When the arrangement of the plurality of packing boxes can no longer be changed (S46: NO), the CPU 12 identifies, from among one or more overall packing boxes predicted in S45, the overall packing box having the smallest volume. The CPU 12 predicts, on the basis of the overall packing box having the smallest volume, a shipping fee for collectively delivering the plurality of products, and causes the shipping fee to be displayed on the interface screen (S48). Through the above processing, a shipping fee for collectively delivering the plurality of products accommodated in the overall packing box is automatically and appropriately predicted.

Next, the CPU 12 calculates a difference between the prediction result of the shipping fee for collectively delivering the plurality of products (the result predicted in S48) and the total price of the prediction results of the shipping fees for separately delivering the plurality of products. The CPU 12 causes the calculated difference to be displayed on the interface screen. Accordingly, the user can easily and appropriately grasp a price that can be saved by having the plurality of products delivered collectively. Note that, as a method for predicting shipping fees for separately delivering the plurality of products, processing similar to that of S22 in the above embodiment (see FIG. 4) can be employed.

### Second Modification

A second modification of the above embodiment will be described. The purchase assistance system 1 according to the second modification of the above embodiment also takes into consideration the prediction result of the HS code of a product when performing tariff prediction processing (S25, see FIG. 4). An HS code is a code for classifying goods in international trade. The tariff rate is predetermined for each HS code of a product. Accordingly, since the tariff is predicted in consideration of the prediction result of the HS code as well, the accuracy of tariff prediction is appropriately improved.

In the second modification, the HS code is predicted by using a mathematical model for HS code prediction. The mathematical model for HS code prediction is trained by a machine learning algorithm so as to output a prediction result of the HS code of a product when information on the product (for example, at least part of the necessary information on the product extracted in S11 to S17 of FIG. 4) is input. As an example, the mathematical model of the second modification is trained according to a machine learning algorithm using information on a product as input training data and a correct HS code designated by an operator who has grasped the information on the product as output training data. Further, when the prediction result output by the mathematical model for HS code prediction differs from the correct HS code, the mathematical model is trained again based on the incorrect prediction result. As a result, the prediction accuracy of the HS code is further improved. The CPU 12 inputs information on a product (necessary information) listed on a WEB page into the mathematical model, thereby acquiring the prediction result of the HS code output by the mathematical model. The CPU 12 predicts a tariff when exporting the product on the basis of the prediction result of the HS code.

Further, in the purchase assistance system 1 according to the second modification, the CPU 12 identifies, on the basis of the predicted HS code, a rule that poses an issue in customs clearance procedures. The CPU 12 notifies the user of the identified rule. Depending on the classification of a product by the HS code, rules such as a rule restricting the export quantity and a rule prohibiting export may be stipulated in customs clearance procedures. Accordingly, by notifying the user of rules in customs clearance procedures on the basis of the predicted HS code, the user can more appropriately determine whether or not to purchase the product.

Further, in the second modification, a mathematical model for predicting product attributes is constructed. The mathematical model for predicting product attributes is trained by a machine learning algorithm so as to output a prediction result of an attribute of the product (for example, at least one of attributes such as a used product, a refrigerated product, a frozen product, a large-sized product, a product close to its expiration date, and a product detained in customs) when information on the product is input. The CPU 12 acquires, by inputting information on the product into the mathematical model for predicting product attributes, a prediction result of the attribute of the product output by the mathematical model. The CPU 12 notifies the user of the acquired information on the attribute of the product. Accordingly, the user can appropriately determine whether or not to purchase the product after appropriately understanding the product attributes.

Further, the purchase assistance system 1 according to the second modification calculates, using the shipping cost predicted in S22 and the customs duty predicted in S25, a total cost required for the user to purchase the product, and causes settlement of the total cost by the user to be completed in advance before completion of delivery of the product. Accordingly, the user can grasp, at an early stage before receiving the product, the total cost required to purchase the product, and therefore can more easily make a decision as to whether or not to purchase the product. Note that the purchase assistance system 1 according to the second modification neither bills nor refunds the difference to the user even when the predicted total cost differs from the actual total cost incurred. As a result, the number of times of payment and receipt of money with the user is less likely to increase, and the procedure for purchasing the product is simplified.

### Third Modification

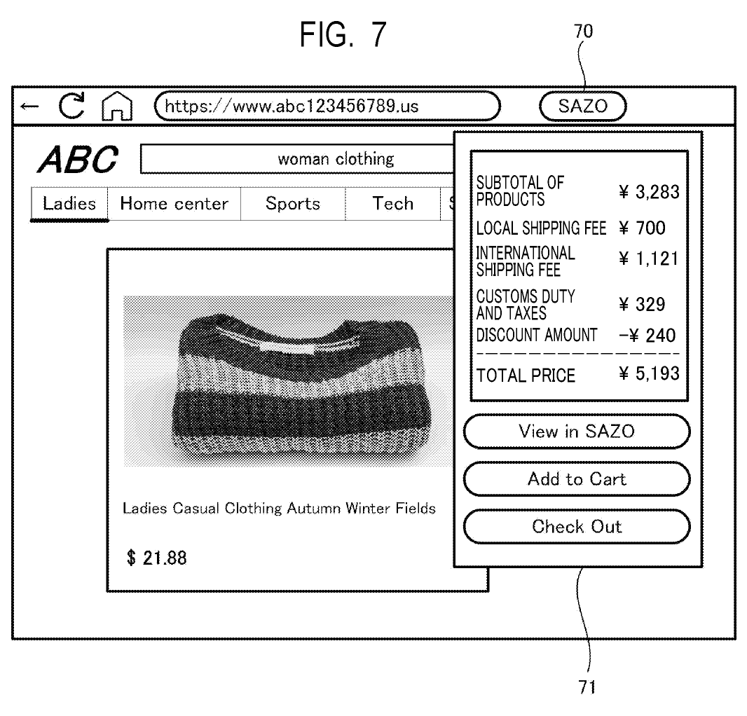

With reference to FIG. 7, a third modification of the above embodiment will be described. As shown in FIG. 7, the purchase assistance system 1 according to the third modification causes a dedicated icon 70, for allowing the user to instruct display of information on a product listed on a WEB page, to be displayed on a generic interface screen. The dedicated icon 70 is displayed on the generic interface screen together with the WEB page on which the product is listed. When the user wishes to check information on the product listed on the WEB page on the interface screen, the user operates the dedicated icon 70. When the dedicated icon 70 is operated by the user, the CPU 12 of the purchase assistance system 1 identifies the WEB page that was displayed on the generic interface screen when the dedicated icon 70 was operated. The CPU 12 automatically extracts, from HTML of the identified WEB page, necessary information on the product listed on the WEB page. For the processing of automatically extracting the necessary information, processing similar to S11 to S17 (see FIG. 4) of the above embodiment can be adopted. Further, the CPU 12 executes processing for predicting the shipping cost of the product (S21 to S22, see FIG. 4) and processing for predicting customs duty (S25, see FIG. 4). The CPU 12 causes the extended browser 71 to be displayed on the generic interface screen. The CPU 12 causes information on the product including the necessary information to be displayed on the extended browser 71. Accordingly, while the WEB page on which the product desired to be purchased is listed is displayed on the interface screen, the user can grasp the information on the product on the extended browser.

In the example shown in FIG. 7, the CPU 12 causes the price of the product, the predicted shipping cost, and the predicted customs duty to be displayed on the extended browser 71. Further, in the example shown in FIG. 7, the CPU 12 causes an "Add to Cart" button and a "View in SAZO" button to be displayed on the extended browser 71 together with the information on the product. When the "Add to Cart" button is operated, the CPU 12 adds the product whose information is displayed on the extended browser 71 to the cart. Further, when the "View in SAZO" button is operated, the CPU 12 newly displays the dedicated interface screen exemplified in the above embodiment.

### Fourth Modification

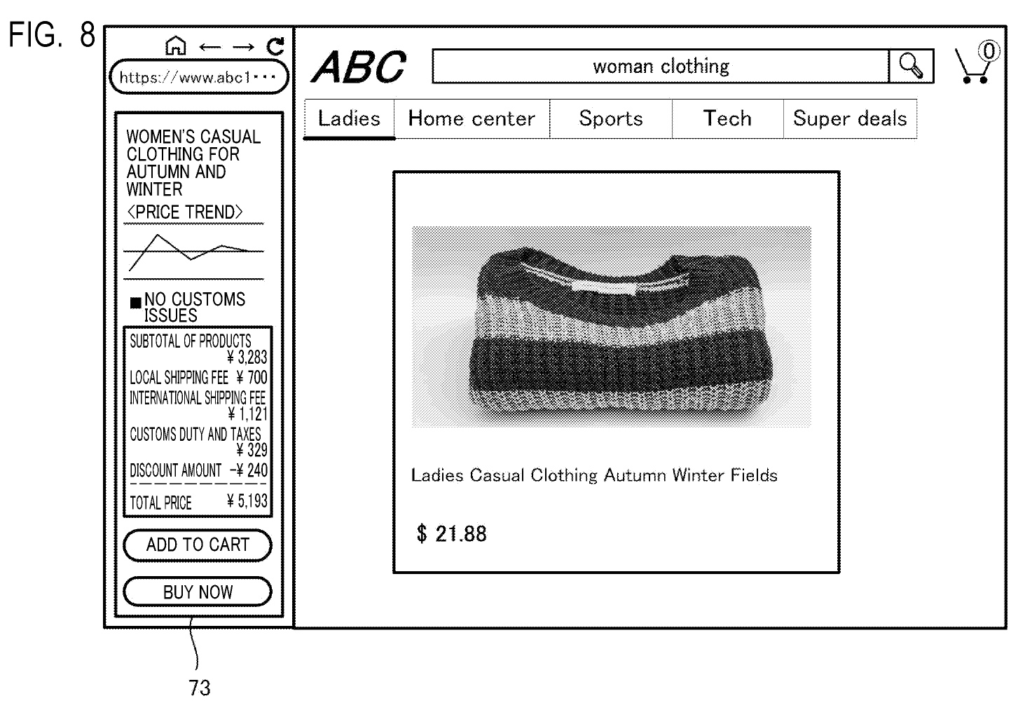

With reference to FIG. 8, a fourth modification of the above embodiment will be described. The purchase assistance system 1 according to the fourth modification determines, each time the WEB page displayed on the general-purpose interface screen is updated, whether or not a product is listed on the displayed WEB page (that is, whether or not the displayed page is a product listing page). As one example, in the fourth modification, a mathematical model that outputs a probability that the WEB page displayed on the general-purpose interface screen is a product listing page is constructed in advance according to a machine learning algorithm. The CPU 12 acquires a probability that the WEB page is a product listing page by inputting information on the displayed WEB page (for example, HTML or the like) into the mathematical model. The CPU 12 determines whether or not the displayed WEB page is a product listing page based on the acquired probability.

As shown in FIG. 8, when the displayed WEB page is a product listing page, the CPU 12 causes an auxiliary browser 73 that displays information for assisting purchase of the product by the user to be displayed on the interface screen together with the WEB page. The CPU 12 identifies the WEB page displayed on the interface screen when causing the auxiliary browser 73 to be displayed. The CPU 12 automatically extracts, from the HTML of the identified WEB page, necessary information on the product listed on the WEB page. For the process of automatically extracting the necessary information, the same process as S11 to S17 of the above embodiment (see FIG. 4) can be employed. Furthermore, the CPU 12 executes a process of predicting the shipping cost of the product (S21 to S22, see FIG. 4) and a process of predicting customs duty (S25, see FIG. 4). The CPU 12 causes information on the product including the necessary information to be displayed on the extended browser 71. Accordingly, while the WEB page on which the product is listed is displayed on the interface screen, the user can grasp, on the automatically displayed auxiliary browser 73, information on the product including the extracted necessary information.

In the example shown in FIG. 8, the CPU 12 causes the price of the product, the predicted shipping cost, and the predicted customs duty to be displayed on the auxiliary browser 73. Further, in the example shown in FIG. 8, the CPU 12 causes an "Add to Cart" button and a "Buy Now" button to be displayed on the auxiliary browser 73 together with the information on the product. Further, in the example shown in FIG. 8, the CPU 12 causes price transition information indicating a transition in the price of the product (a price transition graph in FIG. 8) to be displayed on the auxiliary browser 73. Furthermore, in the example shown in FIG. 8, the CPU 12 causes information of "No customs clearance problem," which is one type of attribute of the product described in the second modification, to be displayed on the auxiliary browser 73.

### Fifth Modification

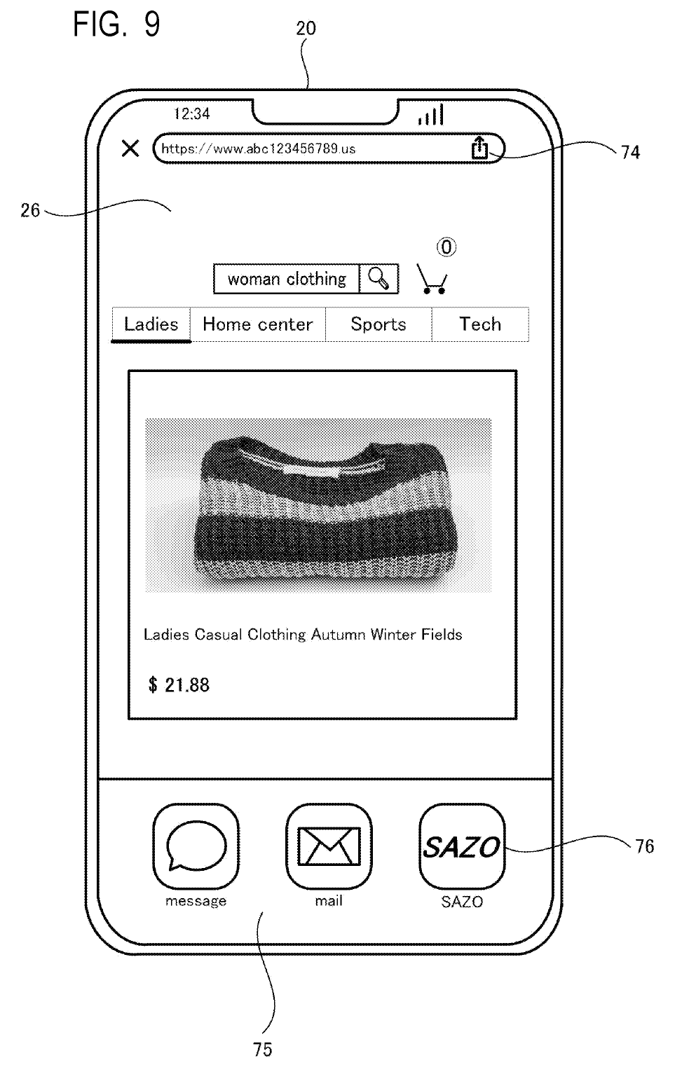

A fifth modification of the above embodiment will be described with reference to FIG. 9. On the display unit 26 of the user terminal 20 shown in FIG. 9, an information sharing instruction button 74, which is operated to instruct execution of an information sharing function of the user terminal 20, is displayed together with a WEB page on which a product is displayed. The user operates the information sharing instruction button 74 when causing the information of the WEB page displayed at that time to be shared with another application. When the information sharing instruction button 74 is operated, the user terminal 20 causes an information sharing icon field 75 to be displayed on the display unit 26. In the information sharing icon field 75, icons corresponding to respective ones of a plurality of applications that are candidates for sharing information are displayed. When causing the information of the WEB page displayed at that time to be shared with the dedicated application described in the above embodiment, the user operates, among the plurality of icons displayed in the information sharing icon field 75, an icon 76 corresponding to the dedicated application. As a result, a sharing operation for causing the information to be shared with the dedicated application is input to the user terminal 20. When the sharing operation is input to the user terminal 20, the user terminal 20 activates the dedicated application. When the sharing operation is performed on the user terminal 20, the purchase assistance system 1 identifies the WEB page displayed on the interface screen of the user terminal 20. The purchase assistance system 1 automatically extracts, from the HTML of the identified WEB page, necessary information on the product listed on the WEB page. For the process of automatically extracting the necessary information, the same process as S11 to S17 of the above embodiment (see FIG. 4) can be employed. Furthermore, the purchase assistance system 1 executes a process of predicting the shipping cost of the product (S21 to S22, see FIG. 4) and a process of predicting customs duty (S25, see FIG. 4). The purchase assistance system 1 causes information on the product including the necessary information to be displayed on the interface screen of the user terminal 20. According to the fifth modification, smooth purchase of the product is performed by use of the information sharing function provided in the user terminal 20.

The technology disclosed in the above embodiment and modifications is merely an example. Accordingly, the technology exemplified in the above embodiment and modifications may also be changed. For example, it is also possible to execute only a part of the technology exemplified in the above embodiment and modifications. Specifically, other processing may be executed while omitting the customs duty prediction/display processing shown in S25 and S26 of FIG. 4. Further, other processing may be executed while omitting the shipping cost prediction/display processing shown in S21 to S23 of FIG. 4. Further, it is also possible to use, in combination, a plurality of technologies exemplified in the above embodiment and modifications.

The process of acquiring page identification information in S5 and S6 of FIG. 2 is an example of a "page identification information acquisition step." The process of automatically extracting necessary information in S11 to S15 of FIG. 4 is an example of an "extraction step." The process of causing the necessary information to be displayed on the interface screen in S20 of FIG. 4 is an example of a "necessary information display step." The structural analysis process executed in S14 of FIG. 4 is an example of a "structural analysis step." The AI utilization process executed in S15 of FIG. 4 is an example of an "AI utilization step." The process of acquiring physical information on the product in S21 of FIG. 4 is an example of a "physical information acquisition step." The process of predicting the shipping cost of the product in S22 of FIG. 4 is an example of a "shipping cost prediction step." The process of causing the predicted shipping cost to be displayed on the interface screen in S23 of FIG. 4 is an example of a "predicted shipping cost display step." The process of predicting customs duty in S25 of FIG. 4 is an example of a "customs duty prediction step." The process of causing the predicted customs duty to be displayed on the interface screen in S26 of FIG. 4 is an example of a "predicted customs duty display step." The process of causing a link to be displayed in S27 of FIG. 4 is an example of a "link display step."

1. A purchase assistance method executed in a purchase assistance system that assists a user in purchasing a product overseas from a country of residence of the user via an interface screen displayed on a user terminal used by the user, the purchase assistance method comprising:
a page identification information acquisition step of acquiring, via the interface screen, page identification information for identifying a WEB page on which a product that the user desires to purchase is listed;
an extraction step of automatically extracting, from HTML of the WEB page identified by the page identification information, necessary information from among information of the product listed on the WEB page; and
a necessary information display step of displaying at least a part of the necessary information extracted in the extraction step on the interface screen.

2. The purchase assistance method according to claim 1, further comprising
in the extraction step, analyzing an HTML structure of the WEB page identified by the page identification information to automatically extract the necessary information.

3. The purchase assistance method according to claim 1, further comprising
in the extraction step, extracting the necessary information by inputting the HTML of the WEB page identified by the page identification information into a mathematical model trained by a machine learning algorithm to extract and output the necessary information on the WEB page.

4. The purchase assistance method according to claim 1, wherein
the extraction step further comprises:
a structural analysis step of automatically extracting the necessary information by analyzing an HTML structure of the WEB page identified by the page identification information; and
an AI utilization step of extracting the necessary information by inputting the HTML of the WEB page identified by the page identification information into a mathematical model trained by a machine learning algorithm to extract and output the necessary information on the WEB page, and
the structural analysis step and the AI utilization step are selectively executed in accordance with the WEB page identified by the page identification information.

5. The purchase assistance method according to claim 1, further comprising:
when the WEB page identified by the page identification information is displayed in a language of a foreign country different from the country of the user, in the necessary information display step,
automatically translating at least a part of the necessary information extracted from HTML in the extraction step into the language of the country of the user; and
displaying the at least a part of the necessary information translated on the interface screen.

6. The purchase assistance method according to claim 1, further comprising
in the page identification information acquisition step, acquiring, as the page identification information, a URL of a WEB page input by the user on the interface screen displayed on the user terminal.

7. The purchase assistance method according to claim 1, further comprising:
a physical information acquisition step of acquiring physical information of the product listed on the WEB page by inputting at least one item of the necessary information extracted in the extraction step into a mathematical model trained by a machine learning algorithm to output physical information of the product;
a shipping cost prediction step of predicting a shipping cost for the product listed on the WEB page based on the physical information acquired in the physical information acquisition step; and
a predicted shipping cost display step of displaying the shipping cost predicted in the shipping cost prediction step on the interface screen.

8. The purchase assistance method according to claim 7, further comprising
in the physical information acquisition step, acquiring physical information of the product listed on the WEB page by inputting a plurality of types of the necessary information extracted in the extraction step into the mathematical model.

9. The purchase assistance method according to claim 7, further comprising:
in the shipping cost prediction step,
applying, to the physical information acquired in the physical information acquisition step, an algorithm for predicting an appropriate packaging box from among a plurality of types of packaging boxes each having a rectangular parallelepiped shape; and
predicting a shipping cost of the product based on the packaging box predicted by the algorithm.

10. The purchase assistance method according to claim 7, further comprising:
when a plurality of candidate products for purchase are selected by the user, acquiring the physical information of each of the plurality of selected products in the physical information acquisition step; and
in the shipping cost prediction step, predicting a shipping cost for collectively delivering the plurality of products based on the physical information of each of the plurality of products acquired in the physical information acquisition step.

11. The purchase assistance method according to claim 10, further comprising:
in the shipping cost prediction step,
applying, to the physical information of each of the plurality of products acquired in the physical information acquisition step, an algorithm for predicting an appropriate packaging box from among a plurality of types of packaging boxes each having a rectangular parallelepiped shape;
while changing an arrangement of the plurality of predicted packaging boxes, predicting a plurality of times an overall packaging box capable of accommodating all of the plurality of arranged packaging boxes; and
predicting a shipping cost for collectively delivering the plurality of products based on the overall packaging box having a smallest volume among a plurality of predicted overall packaging boxes.

12. The purchase assistance method according to claim 10, further comprising:
when a plurality of candidate products for purchase are selected by the user, calculating a difference between a predicted shipping cost for collectively delivering the plurality of selected products and a total amount of predicted shipping costs for separately delivering the plurality of selected products; and displaying the difference on the interface screen.

13. The purchase assistance method according to claim 1, further comprising:
a customs duty prediction step of predicting, based on information on a product listed on the WEB page specified by the page identification information, a customs duty imposed when the product is imported into the country of the user; and
a predicted customs duty display step of displaying the customs duty predicted in the customs duty prediction step on the interface screen.

14. The purchase assistance method according to claim 13, further comprising
in the customs duty prediction step, acquiring a prediction result of customs duty imposed on the product by inputting information on the product listed on the WEB page specified by the page identification information into a mathematical model trained by a machine learning algorithm to output a prediction result of customs duty.

15. The purchase assistance method according to claim 14, further comprising
in the customs duty prediction step, acquiring a prediction result of customs duty imposed on the product by inputting a plurality of pieces of information on the product listed on the WEB page specified by the page identification information into the mathematical model.

16. The purchase assistance method according to claim 14, further comprising:
in the customs duty prediction step,
by using a Retrieval-Augmented Generation (RAG) architecture that is configured to search for specific information from a set of texts and generate new text based on the searched information, acquiring a text indicating characteristics of the product from a set of texts relating to the product listed on the WEB page identified by the page identification information; and
acquiring a prediction result of customs duty imposed on the product by inputting the acquired text into the mathematical model.

17. The purchase assistance method according to claim 13, further comprising:
in the customs duty prediction step,
acquiring a prediction result of an HS code of the product by inputting, into a mathematical model trained by a machine learning algorithm to output a prediction result of the HS code for classifying international trade products, information on the product listed on the WEB page identified by the page identification information; and
predicting the customs duty based on the prediction result of the HS code.

18. The purchase assistance method according to claim 1, further comprising
a link display step of displaying, on the interface screen, a link designated by the user to display the WEB page identified by the page identification information.

19. The purchase assistance method according to claim 1, further comprising:
a dedicated icon display step of displaying, on the interface screen together with a WEB page on which a product desired to be purchased by the user is listed, a dedicated icon for instructing display of information on the product including the necessary information extracted in the extraction step;
when the dedicated icon is operated by the user,
in the page identification information acquisition step, specifying the WEB page that was displayed on the interface screen when the dedicated icon was operated;
in the extraction step, automatically extracting the necessary information from HTML of the specified WEB page; and
in the necessary information display step, displaying an extended browser on the interface screen and displaying information on the product including the necessary information on the displayed extended browser.

20. The purchase assistance method according to claim 1, further comprising:
an auxiliary browser display step of displaying, when a WEB page on which a product is listed is displayed on the interface screen, an auxiliary browser that displays, on the interface screen together with the WEB page, information for assisting the user in purchasing the product;
when the auxiliary browser is displayed,
in the page identification information acquisition step, identifying the WEB page that was displayed on the interface screen when the auxiliary browser was displayed;
in the extraction step, automatically extracting the necessary information from HTML of the identified WEB page; and
in the necessary information display step, displaying information on the product including the necessary information on the displayed auxiliary browser.

21. A non-transitory, computer readable, storage medium storing a purchase assistance program executed in a purchase assistance system that assists a user in purchasing an overseas product from a country of residence of the user via an interface screen displayed on a user terminal used by the user, the purchase assistance program, when executed by a control unit of the purchase assistance system, causing the purchase assistance system to execute:
a page identification information acquisition step of acquiring, via the interface screen, page identification information that identifies a WEB page on which a product that the user desires to purchase is listed;
an extraction step of automatically extracting, from HTML of the WEB page identified by the page identification information, necessary information from among information on the product listed on the WEB page; and
a necessary information display step of displaying at least a part of the necessary information extracted in the extraction step on the interface screen.

22. A purchase assistance system for assisting, via an interface screen displayed on a user terminal used by a user, the user in purchasing an overseas product from a country of residence of the user, comprising:
at least one processor; and
at least one memory storing computer readable code, wherein
the at least one processor, by executing the computer readable code, is configured to cause the purchase assistance system to execute:
a page identification information acquisition step of acquiring, via the interface screen, page identification information that identifies a WEB page on which a product that the user desires to purchase is listed;
an extraction step of automatically extracting, from HTML of the WEB page identified by the page identification information, necessary information from among information on the product listed on the WEB page; and
a necessary information display step of displaying at least a part of the necessary information extracted in the extraction step on the interface screen.

23. An AI-utilizing cross-border EC system for assisting, via an interface screen displayed on a user terminal used by a user, the user in purchasing an overseas product from a country of residence of the user, comprising:
at least one processor; and
at least one memory storing computer readable code, wherein
the at least one processor, by executing the computer readable code, is configured to execute:
a page identification information acquisition step of acquiring, via the interface screen, page identification information that identifies a WEB page on which a product that the user desires to purchase is listed;
an extraction step of automatically extracting necessary information by inputting HTML of the WEB page identified by the page identification information into a mathematical model trained by a machine learning algorithm to extract and output the necessary information; and
a necessary information display step of displaying at least a part of the necessary information extracted in the extraction step on the interface screen.
